(19) United States
(12) Patent Application Publication
(10) Pub. No.: US 2017/0076754 A1
(43) Pub. Date: Mar. 16, 2017

(54) SYSTEMS AND METHODS FOR MATCHING TWO OR MORE DIGITAL MULTIMEDIA FILES

(71) Applicant: EVERGIG MUSIC S.A.S.U., Paris (FR)

(72) Inventor: Hippolyte Pello, Paris (FR)

(73) Assignee: EVERGIG MUSIC S.A.S.U., Paris (FR)

(21) Appl. No.: 14/851,153

(22) Filed: Sep. 11, 2015

(51) Int. Cl. G11B 27/10; G06K 9/00; G11B 27/031

(52) U.S. Cl. CPC G11B 27/10; G11B 27/031; G06K 9/00744

(57) ABSTRACT

Systems and computer-implemented methods match two digital videos previously recorded at a same event. The systems and methods provide a group of digital videos to a computer system, wherein each digital video comprises digital audio and digital video signals previously recorded at the same event, wherein the digital videos are previously recorded by different digital mobile devices and are previously at least temporally synchronized with respect to each other and aligned on a timeline of the same event, wherein a set of instants in time within the timeline of the same event is predefined. The systems and methods extract, at a first instant in time, a first digital image from a first digital video and a second digital image from the second digital video of the group, wherein the first and second digital videos are present at the first instant in time. The systems and methods match the extracted first and second digital images based on one or more scale-invariant feature transform descriptors to identify a matching pair of videos for first instant in time and estimate a fundamental matrix for the matching pair of digital videos. The systems and methods derive an essential matrix for the matching pair of digital videos from the estimated fundamental matrix and assumptions on camera calibration and extract a relative pose between the first and second cameras utilized to record the matching pair of digital videos from the derived essential matrix.

### FIELD OF DISCLOSURE

The present systems and methods match two or more digital multimedia files (hereinafter “videos”), wherein the videos comprise both digital audio signals or tracks (hereinafter “audio signals”) and digital video signals or tracks (hereinafter “video signals”) of a previously recorded same audio/video performance and/or event (hereinafter “same event”). Additionally, the videos may have previously been obtained from a database or uploaded to and/or obtained from an online website and/or computer server, and the previously recorded same event may be any type of recorded event. In one embodiment, the same event may be an entire concert, a portion of said concert, an entire song, and a portion of said song and/or the like. The videos have previously been synchronized, or at least temporally synchronized, and aligned on a timeline of the same event by systems and methods for chronologically ordering digit media and approximating a timeline of the same event based on the audio signals of the videos as disclosed in U.S. Ser. No. 14,697,924 (hereinafter “the '924 application”), which is incorporated herein by reference, in its entirety. The video signals of the videos comprise or contain a plurality of digital images (hereinafter “images”), each image of each of video corresponds to a specific instant, moment or point in time on or within the timeline of the same event, and the videos were previously recorded during the same event by different portable digital devices (hereinafter “device”) at or with different points of view of the same event.

Additionally, the present systems and methods execute, implement and/or utilize one or more computer-implemented methods, one or more computer instructions, one or more computer algorithms and/or computer software (hereinafter “computer instructions) to (i) match one or more pairs of videos based on the images contained within the pairs of videos, (ii) extract and/or estimate relative poses between pairs of different devices utilized to previously record the matched pairs of videos, and/or to extract and/or (iii) estimate additional information with respect to different points of view of the pairs of different devices based on the extracted and/or estimated relative poses. In an embodiment, the additional information with respect to the different points of view of the different devices may be utilized to determine, calculate and/or identify, for example, scale ratios, three-dimensional (hereinafter “3D”) relative positions of the different devices, 3D rotational angles and/or axes of the different devices, portrait-landscape detection, final multi-angle digital video editing and/or video copy detection.

### SUMMARY OF THE DISCLOSURE

In embodiments, systems and/or computer-implemented methods match one or more digital videos previously recorded at a same event. The systems and/or methods may provide a group of digital videos to a computer system as input files, wherein each digital video of the group comprises digital audio and digital video signals previously recorded at the same event, wherein the digital videos of the group are previously recorded at the same event by different digital mobile devices and are previously synchronized, or at least temporally synchronized, with respect to each other and aligned on a timeline of the same event, wherein a set of instants in time along or within the timeline of the same event is predefined. Further, the systems and/or methods may extract digital images from the digital video signals of the digital videos of the group that are present or available at each instant in time along or within the timeline of the same event, match the extracted digital images, for each instant in time, based on one or more scale-invariant feature transform descriptors to identify matching pairs of digital videos for each instant in time, and determine a fundamental matrix for each matching pair of digital videos. Moreover, the systems and methods may determine an essential matrix for each matching pair of digital videos based on the fundamental matrix for each matching pair of digital videos and assumptions on camera calibration associated with cameras of the different digital mobile devices utilized to previously record each matching pair of digital videos, and determine a relative pose between the cameras of the different digital mobile devices utilized to previous record each matching pair of digital videos based on the essential matrix.

In an embodiment, the relative pose between the cameras may comprise relative positions and orientations between the cameras.

In an embodiment, the systems and/or methods may extract information associated with different points of view of the different cameras from the determined relative pose of the cameras.

In an embodiment, the extracted information may comprise at least one selected from a scale ratio, a three-dimensional relative position and a three-dimensional rotation angle and axis.

In an embodiment, the systems and/or methods may edit and produce a final multi-angle digital video of the same event, comprising one or more of the digital videos of the group, based on the extracted information.

In an embodiment, each instant in time may occur every one or more seconds, or ten or less seconds, within or along the timeline of the same event.

In an embodiment, systems and/or computer-implemented methods matching two digital videos previously recorded at a same event and may provide a group of digital videos to a computer system as input files, wherein each digital video of the group comprises digital audio and digital video signals previously recorded at the same event, wherein the digital videos of the group are previously recorded at the same event by different digital mobile devices and are previously synchronized, or at least temporally synchronized, with respect to each other and aligned on a timeline of the same event, wherein a set of instants in time along or within the timeline of the same event is predefined. Further, the systems and/or methods may extract, at a first instant in time of the set of instants, a first digital image from the digital video signals of a first digital video of the group and a second digital image from the digital video signal of a second digital video of the group, wherein the first and second digital videos are present or available in the group at the first instant in time and match the extracted first and second digital images, for the first instant in time, based on one or more scale-invariant feature transform descriptors to identify a matching pair of videos for first instant in time comprising the first and second videos. Still further, the systems and methods may estimate a fundamental matrix for the matching pair of digital videos and derive an essential matrix for the matching pair of digital videos from the estimated fundamental matrix and assumptions on camera calibration associated with a first camera utilized to record the first digital video and a second camera utilized to record the second digital video. Moreover, the systems and methods may extract a relative pose between the first and second cameras utilized to record the matching pair of digital videos from the derived essential matrix, wherein the relative pose between the first and second cameras comprises relative positions and orientations between the first and second cameras.

In an embodiment, the systems and/or methods may extract information associated with different points of view of the first and second cameras from the extracted relative pose of the cameras.

In an embodiment, the extracted information may comprise at least one selected from scale ratios of the first and second cameras, three-dimensional relative positions of the first and second cameras, and three-dimensional rotation angles and axes of the first and second cameras.

In an embodiment, the systems and/or methods may produce a final multi-angle digital video of the same event, comprising at least one selected from the first digital video of the group and the second digital video of the group.

In an embodiment, the systems and/or methods may edit the final multi-angle digital video based on the extracted information and/or the extracted relative pose.

In an embodiment, each instant in time may occur every one or more seconds, or ten or less seconds, within the timeline of the same event.

### BRIEF DESCRIPTION OF THE DRAWINGS

The patent or application file contains at least one drawing executed in color. Copies of this patent or patent application publication with color drawing(s) will be provided by the Patent Office upon request and payment of the necessary fee.

So that the above recited features and advantages of the present systems and methods can be understood in detail, a more particular description of the present systems and methods, briefly summarized above, may be had by reference to the embodiments thereof that are illustrated in the appended drawings. It is to be noted, however, that the appended drawing illustrates only typical embodiments of the present systems and methods and are therefore not to be considered limiting of its scope, for the present systems and methods may admit to other equally effective embodiments.

FIG. 1 illustrates a block diagram of a computer system for detecting and/or identifying image feature matches between at least two synchronized videos previously recorded at the same event in an embodiment.

FIG. 2 illustrates a graph, in color, of a group of videos that have previously been synchronized, or at least temporally synchronized, on the timeline of the same event, wherein shown vertical lines represent a given set of instants or moments in time along the timeline of the same event, in an embodiment.

FIG. 3 illustrates a photograph, in color, of image feature matches between two videos or images previously recorded at different views of points during the same event in an embodiment.

FIG. 4 illustrate a 3D scene reconstruction, in color, of the image feature matches shown in FIG. 3, wherein camera image matches are represented by blue axes, 3D triangulated points are shown by blue points and the geometric median of the 3D triangulated points is shown in red, in an embodiment.

FIG. 5 illustrates a graph, in color, of the group of videos on the timeline of the same event, as shown in FIG. 2, having detected connected components for the videos of the group in an embodiment.

FIG. 6 illustrates a graph, in color, of another group of previously synchronized videos on a different timeline of a different performance having different detected connected components for the different videos of the group in an embodiment.

### DETAILED DESCRIPTION OF THE DISCLOSURE

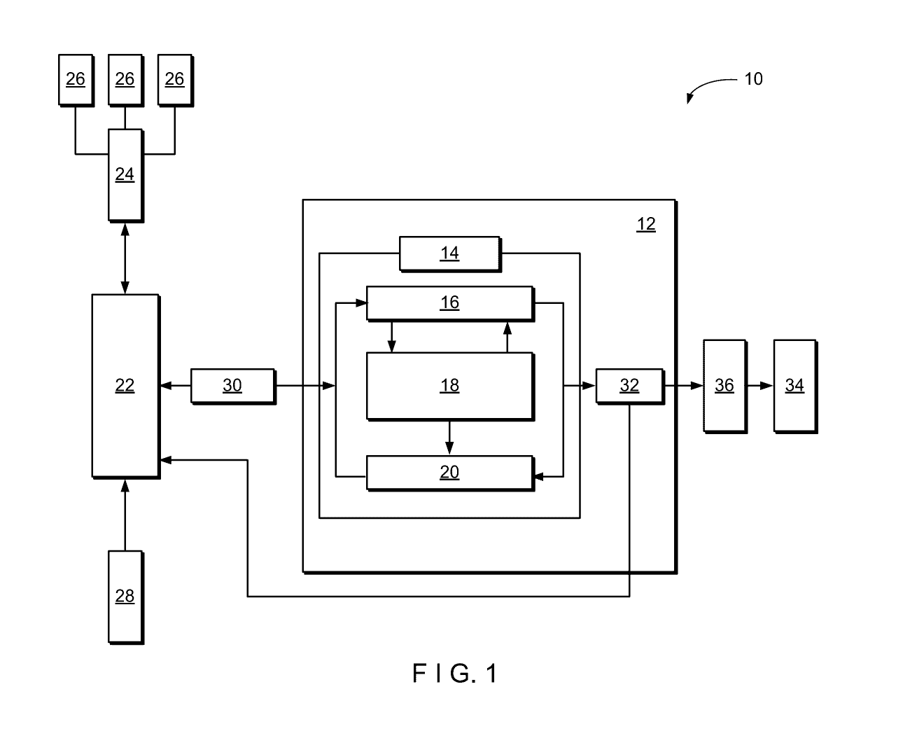

Referring now to the drawings wherein like numerals refer to like parts, FIG. 1 shows a computer system 10 (hereinafter “system 10”) configured and/or adapted for matching two or more digital multimedia videos 26 (hereinafter “videos 26”) or digital images contained within two or more videos 26. Each video 26 comprises both audio signals and digital signals of the previously recorded same event. The videos 26 have previously been synchronized, or at least temporally synchronized, and aligned on the timeline of the same event, based on the audio signals of the videos 26, to produce, create and/or provide a group of videos 26 of the previously recorded same event and/or at least one multi-angle digital video of the same event. The video signals of each video 26 comprise or contain the plurality of the images recorded during the same event, each image of each videos 26 may correspond to a specific instant, moment or point in time on the timeline of the same event, and the videos 26 have been previously recorded during the same event by different portable digital devices 28 (hereinafter “device 28”) at one or more different points of view during the same event.

The present systems 10 and/or methods comprise techniques and/or tools for detecting, identifying and/or determining image feature matches between at least two videos 26 of the group of the videos 26 (hereinafter “the group”). The group may comprise at least two videos 26 previously recorded during the same event which have been synchronized and aligned on the timeline based on audio signal of the videos 26 as disclosed in the '924 application. In embodiments, the videos 26 may have been previously obtained and/or accessed from a database 24 or uploaded to and/or obtained from an online or offline server and/or online website 22 (hereinafter “server/website 22”). In embodiments, the previously recorded same event may be one or more: songs or portions of songs; albums or portion of albums, concerts or portions of concerts; speeches or portions of speeches; musicals or portions of musicals; operas or portion of operas; recitals or portions of recitals; performing arts of poetry and/or storytelling; works of music; artistic forms of expression; and/or other known audio/visual forms of entertainment. In an embodiment, the previously recorded same event is a song or a portion of said song and/or a concert or a portion of said concert.

The system 10 comprises at least one computer 12 (hereinafter “computer 12”) which comprises at least one central processing unit 14 (hereinafter “CPU 14”) having at least one control unit 16 (hereinafter “CU 16”), at least one arithmetic logic unit 18 (hereinafter “ALU 18”) and at least one memory unit (hereinafter “MU 20”). One or more communication links and/or connections, illustrated by the arrowed lines within the CPU 14, allow or facilitate communication between the CU 16, ALU 18 and MU 20 of the CPU 14. One or more methods, one or more computer-implemented steps or instructions, computer algorithms and/or computer software (hereinafter “computer instructions”), for determining, identifying and/or detecting one or more image feature matches between at least two videos 26 of the group, may be uploaded and/or stored on a non-transitory storage medium (not shown in the drawings) associated with the MU 20 of the CPU 14.

The one or more computer instructions may comprise, for example, an image feature matching algorithm (hereinafter “matching algorithm”), a scale-invariant feature transform (hereinafter “SIFT”) algorithm, which may, but does not have to, be based on the Lowe's SIFT features [as defined in “Distinctive Image Features from Scale-Invariant Keypoints,” International Journal of Computer Vision, 60(2):91-110, November 2004 (hereinafter “Lowe”)], a fundamental matrix estimation algorithm (hereinafter “FME algorithm”), a relative pose estimation algorithm (hereinafter “RPE algorithm”) and/or an essential matrix estimation and/or derivation algorithm (hereinafter “EMD algorithm”). When executed by computer 12, one or more of the computer instructions may find, identify and/or detect one or more sets of matching pairs of images or image features of at least two videos 26 of the group based on at least one selected from: at least one considered instant, moment and/or point in time (hereinafter “instant”) during or within the timeline of the same event; one or more utilized SIFT descriptors; one or more estimated fundamental matrices; one or more derived essential matrices; and/or one or more extracted or estimated relative poses between cameras of at least two different devices 28 utilized to recorded the same event at different points of view and/or different angles.

The system 10 may further comprise the server/website 22 and a database 24 which may be local or remote with respect to the computer 12 and/or the server/website 22. The computer 12 may be connected to and/or in digital communication with the server/website 22 and/or the database 24, as illustrated by the arrowed lines extending between the computer 12 and the server/website 22 and between the server/website 22 and the database 24. In an embodiment not shown in the drawings, the server/website 22 may be excluded from the system 10 and the computer 12 may be directly connected to and in direct digital communication with the database 24. A plurality or the group of the videos 26 are stored within the database 24 which are accessible by and transferable to the computer 12 via the server/website 22 or via a direct communication link (not shown in the drawings) between the computer 12 and the database 24 when the server/website 22 is excluded from the system 10.

In embodiments, the videos 26 may be previously recorded audio and video signals of one or more portions of the same event that previously occurred, and the one or more portions of the same event may be one or more durations of time that occurred between a beginning and an end of the same event. The videos 26 comprise original recorded audio and video signals recorded during the same event by the at least two different users via the different devices 28 (i.e., from multiple sources at different angles and/or points of view).

In embodiments, the videos 26 recorded from the multiple sources may have been uploaded, transferred to or transmitted to the system 10 via the devices 28 which may be connectible to the system 10 by a communication link or interface as illustrated by the arrowed line in FIG. 1 between server/website 22 and the device 28. In embodiments, each device 28 may be an augmented reality device, a computer, a digital audio/video recorder, a digital camera, a handheld computing device, a laptop computer, a mobile computer, a notebook computer, a smart device, a tablet computer, a cellular phone, a portable handheld digital video recording device, a wearable computer or a wearable digital device. The present disclosure should not be deemed as limited to a specific embodiment of the videos 26 and/or the devices 28.

In embodiments, the videos 26 that are stored in the database 24 may comprise the group of previously recorded, synchronized videos 26 aligned on the timeline such that their precise exact time location within the timeline of the entire same event or at least one portion of the entire same event is previously known, identified and determined. The CPU 14 may access the group of recorded, synchronized, at least temporally synchronized, and aligned videos 26 as input files 30 (hereinafter “input files 30” or “input 30”) which may be stored in and/or accessible from the database 24. In an embodiment, the CPU 14 may select or request the input videos 30 from the videos 26 of the group stored in the database 24. The CPU 14 may transmit a request for accessing the input videos 30 to the server/website 22, and the server/website 22 may execute the request and transfer the input files 30 to the CPU 14 of the computer 12. The CPU 14 of the computer 12 may execute or initiate the computer instructions stored on the non-transitory storage medium of MU 20 to perform, execute and/or complete one or more computer-implemented algorithms, actions and/or steps associated with the present matching systems and methods. Upon execution, activation, implementation and/or completion of the computer instructions, the CPU 14 may generate, produce, calculate or compute an output 32 which may be dependent of the specific inventive matching method(s) and/or computer instructions being performed and/or executed by the CPU 14 or computer 12. In an embodiment, the output 32 may comprise a final multi-angle digital video of the same event, or at least a portion of the same event, comprising one or more of the videos 26 of the group inputted into the CPU 14 as input 30.

In embodiments, the present system 10, methods and/or computer instructions, upon execution, may process, analyze and/or compare the input files 30, comprising the group of synchronized videos 26 of the same event, to identify, determine and/or detect one or more image feature matches between one or more sets of matching pairs of images contained within at least two videos 26 of the group. Additionally, the one or more sets of matching pairs of images may comprise one or more estimated 3D transforms for each considered instant within or along the timeline of the same event. The system 10, methods and/or computer instructions may consider, or may only consider, a given or predetermined set of instants in time within or along the timeline of the same event. At each instant in time within the given or predetermined set of instants, the present system 10, methods and/or computer instructions may extract an image from each video 26 that is present or available at each instant in time. For each instant in time, the extracted images, extracted from each video 26 present or available at each instant in time, may be matched with each other based on, or by utilizing, one or more SIFT descriptors. As a result, one or more matching pairs of videos 26 may be obtained, determined and/or identified by the present system 10, methods and/or computer instructions based on, or by utilizing, the one or more SIFT descriptors. For each matching pair of videos 26, the present system 10, methods and/or computer instructions may estimate, calculate, determine and/or identify a fundamental matrix for each matching pair of videos. Using assumptions on camera calibration associated with cameras of the different devices 28 utilized to previously record the videos 28 of the group, the present system 10, methods and/or computer instructions may derive, calculate, determine and/or identify an essential matrix for each matching pair of videos 26. From the essential matrix for each matching pair of videos 26, the present system 10, methods and/or computer instructions may estimate, extract, calculate, determine and/or identify a relative pose between, or for, the cameras utilized to previously record the videos 26 of each matching pair of videos 26. In an embodiment, the relative pose may comprise relative and/or 3D positions and/or orientations of different cameras of the different devices 28 utilized to previously record each matching pair of videos 26. From the relative and/or 3D positions and/or orientations, the present system 10, methods and/or computer instructions may estimate, extract, calculate, determine and/or identify point of view information (hereinafter “view information”) associated with different points of view of the different cameras of the different devices 28 utilized to previously record each matching pair of videos 26. In an embodiment, the output 32 may comprise the one or more estimated 3D transforms, the extracted images, the one or more matching pairs of videos 26, the fundamental matrix for each matching pair of videos 26, the essential matrix for each matching pair of videos 26, the relative pose, 3D or relative positions and/or orientations of the different cameras of each matching pair of videos 26 and/or the view information associated with different points of view of the different cameras.

By estimating the relative pose (i.e., relative or 3D positions and orientations) between the different cameras of a matching pair, the present system 10, methods and/or computer instructions may extract, estimate, calculate and/or determine the view information with respect to the different points of view of the different cameras for each matching pair. In an embodiment, the view information may comprise at least one scale ratio, at least one 3D relative position and/or at least one 3D rotation angle and axis for the different cameras of each matching pair. In an embodiment, the output 32 may comprise the at least one scale ratio, the at least one 3D relative position and/or the at least one 3D rotation angle and axis. In embodiment, the view information may be utilized by the present system 10, methods and/or computer instructions to (i) perform, execute and/or facilitate one or more portrait-landscape detections and/or one or more video copy detections based on the video signal of videos 26 of the group, and (ii) produce, create and/or edit a final multi-angle digital video of the same event comprising one or more of the videos 26 of the group.

FIG. 1 shows a group of videos 26 (i.e., horizontal blue segments) of a same event that have previously been at least temporally synchronized as shown along the Y-axis. The set of instants in time along the timeline of the same event (see X-axis) is represented by the red vertical lines. For example, the instants may occur or be present at intervals of time, such as, for example, time intervals of less than one second, of one second, of more than one second and less than five seconds, of five seconds, of greater than five seconds, of ten seconds (see intervals shown in FIG. 1) or of greater than ten seconds.

As set forth above, the input 30 may comprise the group of videos 26 as shown in FIG. 1, and the output 32 may comprise a set of matching pairs of images with an estimated 3D transform for each considered instant within or along the timeline of the same event. The present system 10, methods and/or computer may execute, perform and/or implement the matching algorithm to determine matching pairs of videos based on extracted images at the considered instants within or along the timeline. In an embodiment, the matching algorithm may comprise, or may be, the SIFT algorithm, and the matching and/or SIFT algorithm may only consider instants from the timeline set forth in the given or predetermined set of instants. At each instant, the matching and/or SIFT algorithm may extract an image by the video 26 of the group that are present or available at each instant. For each instant, the matching and/or SIFT algorithm may match the extracted images, extracted from the videos 26 present or available at each instant, with each other, or one another, based, on or by utilizing, the one or more SIFT descriptors to produce, create and identify a set of matching pairs of videos 26. For each matching pair of videos 26, the present system 10, methods, computer instructions and/or the FME algorithm may estimate, calculate, determine and/or identify a fundamental matrix for each matching pair of videos 26. Using assumptions on camera calibration and/or the fundamental matrix, the present system 10, methods, computer instructions and/or the EMD algorithm may derive, calculate, estimate, determine and/or identify an essential matrix for each matching pair of videos 26. The system 10, methods, computer instructions and/or RPE algorithm may extract, calculate, determine and/or identify the relative pose (i.e., 3D or relative position and orientation) between the different cameras of each matching pair from, or based on, the essential matrix of each matching pair.

In embodiment, calibration matrices of the cameras that previously recorded the videos 26 of the group are, or may be, unknown. One or more assumptions, such as, for example, “square pixels” or “principal point at image center” are not, or may not be, very restrictive and are, or may be, done in structure from motion (see M. Brown, et al., “Unsupervised 3D Object Recognition and Reconstruction in Unordered Datasets,” Fifth International Conference on 3-D Digital Imaging and Modeling, 3DIM'05, pages 56-63, (hereinafter “Brown, et al.”)).

However, the focal, which may possibly be varying with t because of zoom is set, or may be set, to an arbitrary value proportional to the image dimensions, corresponding to, for example, a “medium” field of view. As a result, the estimated position of each camera along their own Z-axis is not accurate or may be not accurate most of the time, which may make any 3D reconstruction from more than two cameras difficult, substantially difficult, or impossible. Nevertheless, the position along the Z-axis is, or may be, relevant, as the position along the Z-axis is, or may be, related to the scale ratio between both matching views recorded by different cameras or sources.

Note that if the calibrations of the different cameras of each matching pair may be known at each instant, the present methods and/or computer instructions may provide and/or achieve accurate or substantially accurate results on camera positions of the different cameras and/or may be utilized for 3D reconstruction with more than two different cameras. Moreover, the 3D reconstruction may also be achieved with or by a bundle adjustment approach or method which may estimate the camera calibrations in parallel. However, the bundle adjustment approach or method may require numerous, or substantially numerous, matching views to achieve accurate results, whereby such numerous matching views are sometimes not available and/or present within the group of videos.

In embodiments, the present system 10, methods, computer instructions, matching algorithm and/or SIFT algorithm may be adapted and/or configured to execute, perform and/or implement a SIFT feature matching between at least two videos 26 of the group present or available at each instant on the timeline. At each considered instant on the timeline a set of images, corresponding to the subset of videos 26 that are present or available at each instant, may be considered by the matching or SIFT algorithm. Any and/or all possible pairs of images from the subset may be matched utilizing SIFT features via the matching or SIFT algorithm.

In embodiments, present system 10, methods, computer instructions, matching algorithm and/or SIFT algorithm may perform, execute and/or implement one or more feature extractions from the images of the videos 26 of the group. The images may be searched for SIFT features according to David G. Lowe, “Distinctive Image Features from Scale-Invariant Keypoints,” International Journal of Computer Vision, 60(2):91-110, November 2004 (hereinafter “Lowe”). A SIFT feature as output by Lowe's program (see http://www.cs.ubc.ca/˜lowe/keypoints) comprises a 2D position (x, y) in image coordinates, a scale and orientation (for display purposes), and a descriptor of 128 values between 0 and 255. In embodiments, the present system 10, methods, computer instructions and/or matching algorithm may utilize one or more other types of image matching features which may include Lowe's SIFT and/or other types, such as, for example, but not limited to SURF and/or ORB. As a result, descriptor values may not be restricted to [0, 255] values and/or may not have 128 values.

In an embodiment and with parameters utilized by the present system 10, methods and/or computer instructions, a plurality of features may be extracted for each image (of typically 1280×720 pixels). In embodiments, the plurality of features may be one or more hundreds of features or one or more thousands of features. For the present system 10, methods and/or computer instructions, feature extraction for a single image may take, without parallelization, less than one second, one second or at least one second.

For feature extraction, the present system 10, methods and/or computer instructions may utilize opensift (see http://robwhess.github.io/opensift/) which is based on OpenCV 2.4 or another implementation provided by the VLFeat open source library (see http://www.vlfeat.org/), which yielded similar results as opensift. In embodiments, the present system 10, methods and/or computer instructions may execute, perform and/or implement feature matching with respect to the extracted features of the images of videos 26 of the group. Similarly to Brown, et al., the present system 10, methods and/or computer instructions may match features between two images according to their descriptor utilizing approximate nearest neighbors with the following method: (i) a k-d tree of all features of the second image is built, based on the values of the descriptors (see J. S. Beis, et al., “Shape indexing using approximate nearest-neighbor search in high-dimensional spaces,” Proceedings of IEEE Computer Society Conference on Computer Vision and Pattern Recognition, 1997, pages 1000-1006); (ii) for each feature of the first image, its two nearest neighbors in the k-d tree are returned, and (iii) the first nearest neighbor is checked as a potential match by comparing its match distance with the one of the second nearest neighbor. It is accepted as a match if d_{first match}<N×d_{second match}, where N is between 0 and 1. In one embodiment, it is acceptable as match if d_{first match}<0.6×d_{second match}. To perform the operations of said method, the present system 10, methods and/or computer instruction may utilize an implementation of structure from motion (see https://github.com/snavely/bundler_sfm) provided by Noah Snavely, et al., “Photo Tourism: Exploring Photo Collections in 3D, 2006.

However, it should be understood that one or more precautions may be considered while utilizing the said method for matching features between two images. First, the approximate nearest neighbor matching method may not prevent one or more different features from being matched with the same point in the second image. To avoid this, the present system 10, methods and/or computer instructions may track one or more features of the second image that may appear more than once in detected matches and may only keep the match with the highest confidence. Additionally, SIFT or some other image matching methods such as SURF, ORB may allow different features to be computed at the same location (x, y) which may results in one or more matching pairs detected between the same two points. To prevent said behaviors in further geometric considerations, the present system 10, methods and/or computer instructions may keep one match in such case.

In embodiments, the system 10, methods, computer instructions and/or FME algorithm may estimate, calculate, compute, determine and/or identify a fundamental matrix for each matching pair of videos 26 at each considered instant within the timeline of the same event. In an embodiment, the computer instructions and/or FME algorithm may comprise, or may be, an 8-point algorithm (see R. I. Hartley, “In defense of the eight-point algorithm,” IEEE Transactions on Pattern Analysis and Machine Intelligence, 19(6):580-593, June 1997). Using the 8-point algorithm along with random sample consensus (hereinafter “RANSAC”) for efficient outlier removal, the present computer instructions and/or FME algorithm may calculate, compute, determine and/or identify the fundamental matrix for each matching pair of videos 26. In an embodiment, the present computer instructions and/or FME algorithm may utilize and/or implement Sampson distance (see R Hartley, et al., “Multiple view geometry in computer vision,” 2003) (hereinafter “Hartley, et al.”) instead of algebraic distance to facilitate and/or to achieve good reprojection error estimation.

Apart from being useful and/or helpful for relative pose estimation, the computation, determination and/or identification of the fundamental matrix may also remove one or more false positives or non epipolar feature matches.

In embodiments, a match between two images may be finally accepted or acceptable if the total number of inliers for the fundamental matrix is greater than or equal to a certain or predetermined threshold value. For example, a minimum threshold value may be eight or the minimum number of points necessary for the 8-point algorithm.

However, the present computer instructions and/or FME algorithm may observe, in the data, one or more features belonging to the same 3D plane (e.g. an artist singing in the background). As a result, some wrong matches may appear as correct pairs in another part of the 3D space. To avoid wrong matches, higher threshold values may be utilized or implemented. For example, the threshold value may be, greater than eight, greater than ten, equal to fourteen or greater than fourteen.

In embodiments, the present system 10, methods and/or computer instructions may extract, estimate, calculate, determine and/or identify the relative pose between each matching pair based on the fundamental and/or essential matrices for each matching pair. The present system 10, methods, computer instructions and/or EMD algorithm may estimate, calculate, computer, determine and/or identify the essential matrix for each matching pair based on the fundamental matrix for each matching pair. For example, when given the camera calibrations K₁ and K₂ of the different cameras of a matching pair, the present computer instructions and/or EMD algorithm may recover, calculate, estimate, determine and/or identify the essential matrix E from the fundamental matrix F with the formula:

E=K₂^{T}FK₁ (1)

For each camera, the following the calibration matrix:

$$K = [ \begin{matrix}{f}_{x} & s & {x}_{0} \\ & {f}_{y} & {y}_{0} \\ & & 1\end{matrix} ]$$

is not necessarily known.

In embodiments, the present computer instructions and/or EMD algorithm may make one or more of the following assumptions, by writing w and h as the width and height of the image, in pixels: (i) the skew s is zero; (ii) the principal point (x₀, y₀) is at image center (w/2, h/2); (iii) the pixels are square (i.e. scaling is the same along x and y axis) fₓ=f_{y}=f; and (iv) the focal f equals f=w+h, which corresponds to a “medium” field of view, which may transfer the unknown of the focal length of the camera (including zoom factor) to its position along its z axis.

As a result, the corresponding calibration matrix may be

$${K}_{i} = [ \begin{matrix}w + h & 0 & \frac{w}{2} \\ & w + h & \frac{h}{2} \\ & & 1\end{matrix} ]$$

which may enable for each fundamental matrix F to estimate the essential matrix E using equation 1.

In embodiments, the present system 10, methods and/or computer instructions may extract, estimate, derive, calculate, determine and/or identify a relative orientation and translation between the different cameras of each matching pair based on the fundamental and/or essential matrices of each matching pair. In embodiments, the computer instructions and/or the RPE algorithm may estimate the relative pose for the cameras of each matching pair. To estimate, calculate, determine and/or identify the relative pose between two cameras of a matching pair, the present computer instructions and/or the RPE algorithm may choose, select and/or assign the first camera to be at the origin and oriented within the 3D space. Furthermore, R and t are the rotation and translation parameters of the second camera, that is, cameras have the following normalized (i.e. regardless of their calibration) camera matrices:

P₁=[I|0]

P₂=[R|t]

In an embodiment, the rotation from the first to the second camera axes is then R^{T} while the center of the second camera is C₂=−R^{T}t.

Letting X be a point of the 3D space, its coordinates relative to the second camera are X′=RX+t. As a result, X=R^{T}(X′−t) or X=R^{T}X′+C₂.

According to Hartley et al., the essential matrix E is closely related to R and t by

E=[t]_{×}R

where [t]ₓ is the cross product matrix of t

$${[ t ]}_{x} = [ \begin{matrix}0 & - {t}_{3} & {t}_{2} \\ {t}_{3} & 0 & - {t}_{1} \\ - {t}_{2} & {t}_{1} & 0\end{matrix} ]$$

It may then be possible to recover R and t from E using Hartley et al., by writing

E=UDV^{T}

the SVD of E and

$$W = [ \begin{matrix}0 & - 1 & 0 \\ 1 & 0 & 0 \\ 0 & 0 & 1\end{matrix} ]$$

the 4 possible solutions are

$$\{ \begin{matrix}R = {UWV}^{T} or {UW}^{T} {V}^{T} \\ t = {u}_{3} or - {u}_{3}\end{matrix}$$

with u₃ the third column of matrix U. This formula may only be valid when the non-zero eigenvalues of E (which are equal) equal 1. To recover the global normalization factor, the present computer instructions and/or RPE algorithm may multiply the vector t by this eigenvalue λ, available in the matrix D=diag(λ, λ, 0) for example.

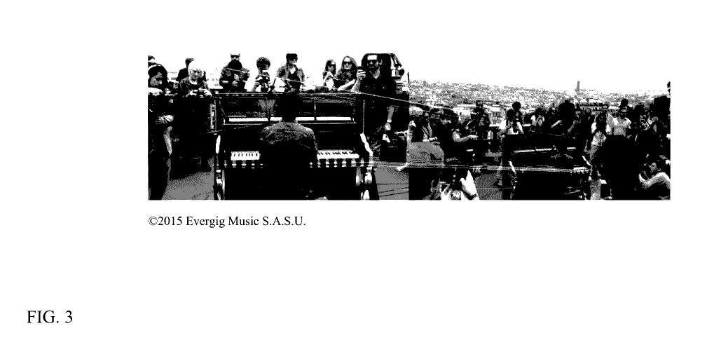

FIG. 3 shows image feature matches within images between two view from two different cameras that previously recorded the same event.

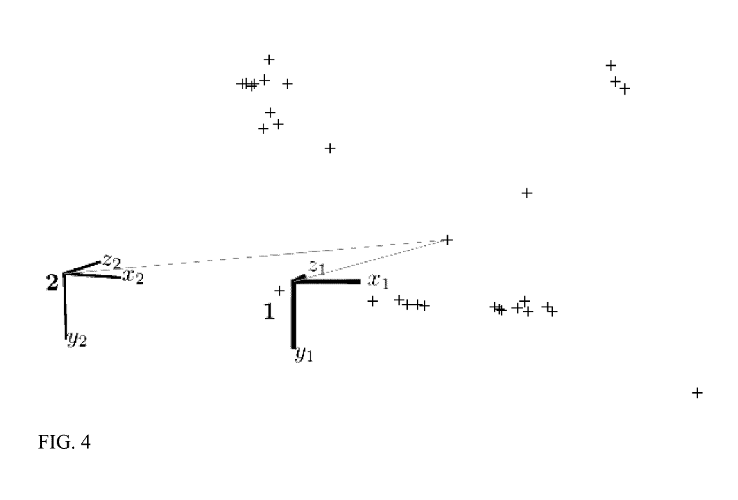

FIG. 4 shows a 3D scene reconstruction of the image feature matches of FIG. 3, wherein the cameras are presented by blue axes, 3D triangulated points are shown by blue lines, and the geometric median is shown in red.

In the example shown in FIGS. 3 and 4, the estimated parameters for second camera are as follows: (i) scale ratio: 0.70; (ii) rotation: 23.41° around (0.24, 0.97, 0.02); and (iii) position: (−0.48, −0.04, −0.28) (in terms of “distance to the scene center”).

A correct pair R, t may then be determined by triangulating the 3D feature points, and choosing the pair that has most (there can be some inliers) feature points in front of both cameras.

In embodiments, the present system 10, methods and/or computer instructions may triangulate 3D points from 2D feature matches. For example, the present system 10, methods and/or computer instructions may triangulate 3D points from 2D feature matches and estimated camera matrices according Hartley et al.

In embodiments, the system 10, methods and/or computer instructions may determine and/or calculate camera parameters for the second camera from the matching pair. For example, the present systems, methods and/or computer instructions may estimate, a position, a scale ratio and/or a 3D rotation between both views of the cameras of the matching pair based on the estimated R and t.

For rotation angle and axis, the rotation from the first camera orientation to the second is R^{T}. Letting θ be the vector such that R^{T}=e^{[θ]x} (available using Rodrigues' formula), then R^{T} is the rotation of angle θ and around the vector [θ]ₓ.

In an embodiment, the position of the second camera is given by C₂=−R^{T}t. However, said position is without a unit. Therefore, the present system 10, methods and/or computer instructions may compute, determine and/or identify the geometric median of the 3D feature points, and normalize C₂ by its length. As a result, the position of the second camera is given in terms of “distance to the scene center”.

For scale ratio, the present system 10, methods and/or computer instructions may calculate, determine and/or identify the distance of each camera center to the geometric median. Thus, the scale ratio is the ratio between these distances.

In embodiments, the present methods and/or computer instructions may be applied to facilitate and/or achieve a portrait-landscape detection. If, for example, one camera of the matching pair was filming or recording in portrait and the second camera was filming or recording in landscape and the relative pose between two cameras is estimated, then the present methods and/or computer instructions may observe R^{T} to be a rotation of ±90° around the z axis.

For video editing, the extracted information, such as, for example, the relative pose and/or the view information may be utilized by the present system 10, methods and/or computer instructions for producing, creating and/or editing the multi-angle final digital video of the same event which comprises one or more of the videos 26 of the group. For example, said extracted information may be utilized by the present system 10, methods and/or computer instructions to prevent the final multi-angle digital video editing from switching between two views or images from two different videos 26 that are, or may be, close, very close, similar, or substantially similar to each another with respect to proximity and/or point of view. As a result, the final multi-angle digital video may be edited based on the extracted and/or view information such that adjacent and/or consecutive views or images do not comprise views or images that are, or may be, close, very close, similar or substantially similar to each other with respect to proximity and/or point of view.

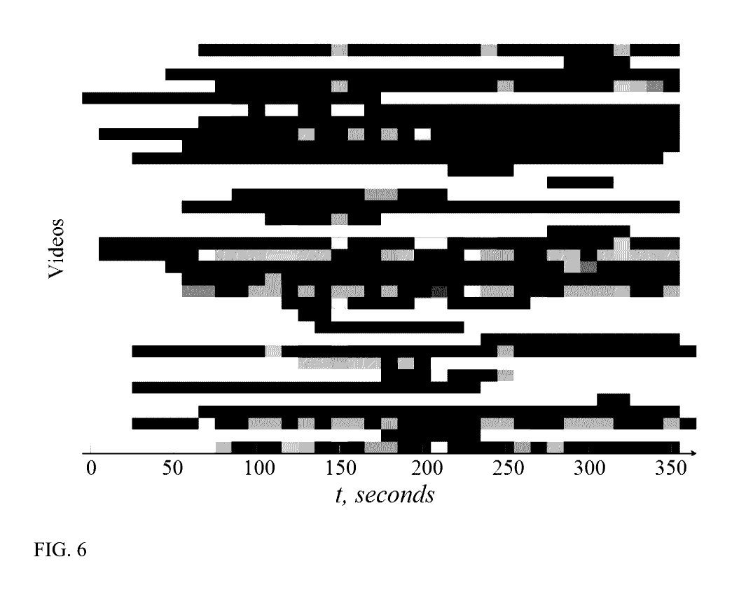

In embodiments, the present system 10, methods and/or computer instructions may detect video copies between two videos 26 of the group based on information contained within the matching pair and/or the extracted information (i.e., the relative pose, the relative or 3D position and/or orientation) and/or the view information. For example, the information contained in a match, the extracted information and/or the view information may be utilized by the present methods and/or computer instructions to determine or to check if two videos 26 of the group are similar, substantially similar, alike or substantially alike as shown in FIG. 6. As a result, the present methods and/or computer instructions may detect when one video 26 of the group may be an exact copy of another video 26 of the group and/or when one video 26 of the group contains an extract of another video 26 of the group. When one video 26 is a copy of, or contains at least an extract of, another video 26 of the group, the number of matching SIFT features may be increased and/or much greater in comparison to a number of extracted features.

With respect to results achievable by the present system 10, methods and/or computer instructions, the matching pairs of videos 26 of the group, the extracted information and/or view information may be utilized to produce, determine and/or identify clustering of one or more videos 26 of the group. For example, one video 26 may be matched with several other videos 26 of the group at each instant along the timeline. As a result, the present system 10, methods and/or computer instructions may group or cluster all of the videos 26 together in connected components views that have matched with one another.

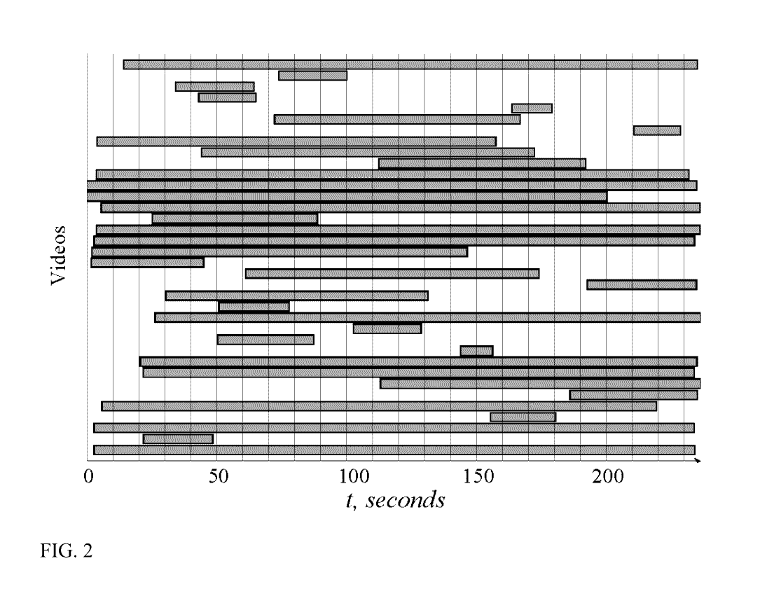

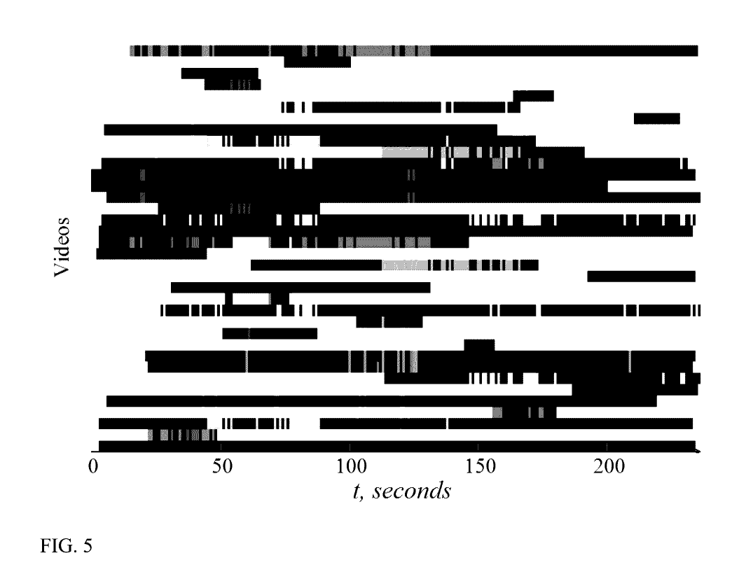

One method for observing said results comprises producing a timeline, in color, containing and/or illustrating the connected components. For example, the present system 10, methods and/or computer instructions may generate, produce, provide and/or create a timeline, in color, with the matching videos and/or may color the connected components with the same color at the instants on the time line where the connected components may match or may be matched. To preserve some unity in coloring, cameras of matching pairs may be sorted by the number of instants when views may have been matched, and a color may be assigned to each camera pair. Then each connected component may receive the color of the strongest pair contained within the connected component. As a result, long segments of the same color may be observed. FIGS. 5 and 6 show such generated timelines, in color. Specifically, FIG. 5 shows a timeline, in color, with one instant occurring every one second and with detected connected components for group of videos 26 shown in FIG. 2. FIG. 6 shows a timeline, in color, with one instant occurring every ten seconds and with detected connected components for another set of videos of another performance, whereby the third and ninth videos from the top of the graph and along the Y-axis match at any instant along the timeline of the said performance.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A computer-implemented method for matching one or more digital videos previously recorded at a same event, the method comprising:
providing a group of digital videos to a computer system as input files, wherein each digital video of the group comprises digital audio and digital video signals previously recorded at the same event, wherein the digital videos of the group are previously recorded at the same event by different digital mobile devices and are previously synchronized, or at least temporally synchronized, with respect to each other and aligned on a timeline of the same event, wherein a set of instants in time along or within the timeline of the same event is predefined;
extracting digital images from the digital video signals of the digital videos of the group that are present or available at each instant in time along or within the timeline of the same event;
matching the extracted digital images, for each instant in time, based on one or more scale-invariant feature transform descriptors to identify matching pairs of digital videos for each instant in time;
determining a fundamental matrix for each matching pair of digital videos;
determining an essential matrix for each matching pair of digital videos based on the fundamental matrix for each matching pair of digital videos and assumptions on camera calibration associated with cameras of the different digital mobile devices utilized to previously record each matching pair of digital videos;
determining a relative pose between the cameras of the different digital mobile devices utilized to previous record each matching pair of digital videos based on the essential matrix.

2. The method according to claim 1, wherein the relative pose between the cameras comprises relative positions and orientations between the cameras.

3. The method according to claim 2, further comprising:
extracting information associated with different points of view of the different cameras from the determined relative pose of the cameras.

4. The method according to claim 3, wherein the extracted information comprises at least one selected from a scale ratio, a three-dimensional relative position and a three-dimensional rotation angle and axis.

5. The method according to claim 3, further comprising:
editing and producing a final multi-angle digital video of the same event, comprising one or more of the digital videos of the group, based on the extracted information.

6. The method according to claim 1, wherein each instant in time occurs every one or more seconds, or ten or less seconds, within or along the timeline of the same event.

7. A computer-implemented method for matching two digital videos previously recorded at a same event, the method comprising:
providing a group of digital videos to a computer system as input files, wherein each digital video of the group comprises digital audio and digital video signals previously recorded at the same event, wherein the digital videos of the group are previously recorded at the same event by different digital mobile devices and are previously synchronized, or at least temporally synchronized, with respect to each other and aligned on a timeline of the same event, wherein a set of instants in time along or within the timeline of the same event is predefined;
extracting, at a first instant in time of the set of instants, a first digital image from the digital video signals of a first digital video of the group and a second digital image from the digital video signal of a second digital video of the group, wherein the first and second digital videos are present or available in the group at the first instant in time;
matching the extracted first and second digital images, for the first instant in time, based on one or more scale-invariant feature transform descriptors to identify a matching pair of videos for first instant in time comprising the first and second videos;
estimating a fundamental matrix for the matching pair of digital videos;
deriving an essential matrix for the matching pair of digital videos from the estimated fundamental matrix and assumptions on camera calibration associated with a first camera utilized to record the first digital video and a second camera utilized to record the second digital video;
extracting a relative pose between the first and second cameras utilized to record the matching pair of digital videos from the derived essential matrix, wherein the relative pose between the first and second cameras comprises relative positions and orientations between the first and second cameras.

8. The method according to claim 7, further comprising:
extracting information associated with different points of view of the first and second cameras from the extracted relative pose of the cameras.

9. The method according to claim 8, wherein the extracted information comprises at least one selected from:
scale ratios of the first and second cameras;
three-dimensional relative positions of the first and second cameras; and
three-dimensional rotation angles and axes of the first and second cameras.

10. The method according to claim 8, further comprising:
producing a final multi-angle digital video of the same event, comprising at least one selected from the first digital video of the group and the second digital video of the group.

11. The method according to claim 10, further comprising:
editing the final multi-angle digital video based on the extracted information and/or the extracted relative pose.

12. The method according to claim 7, wherein each instant in time occurs every one or more seconds, or ten or less seconds, within the timeline of the same event.
